(19) United States
(12) Patent Application Publication
(10) Pub. No.: US 2009/0010184 A1
(43) Pub. Date: Jan. 8, 2009

(54) DEVICE AND METHOD FOR BIDIRECTIONAL COMMUNICATION

(76) Inventors: Vesa Luiro, Kempele (FI); Mika Helander, Oulu (FI); Mikko Hyvarinen, Oulu (FI); Kari Kaarela, Oulu (FI)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(21) Appl. No.: 11/773,637

(22) Filed: Jul. 5, 2007

(51) Int. Cl. H04B 7/00

(52) U.S. Cl. 370/277

(57) ABSTRACT

This application relates to an apparatus comprising at least one interface for connecting to a wireless network. Further the apparatus comprises an advertising unit configured to advertise the presence of the apparatus within the wireless network. The apparatus includes also a presenting unit configured to present at least one mobile service described in a markup language and a transmission unit configured for accepting a request for a bidirectional communication via the wireless network from at least one second apparatus using the presented mobile service.

### FIELD OF THE APPLICATION

This application relates to an apparatus for setting up a bidirectional communication. Further the application relates to a system for setting up a bidirectional communication and a method for setting up a bidirectional communication between two devices. Moreover, the application refers to a computer readable medium having a computer program stored thereon for setting up bidirectional communication.

### BACKGROUND OF THE APPLICATION

Currently all mobile phone calls need a wireless infrastructure to support discovery, connectivity, security and quality of service. This infrastructure is provided by several Mobile Network Operators or Internet Service Providers. These maintaining parties deploy, for example, the Global System for Mobile Communication (GSM) as an infrastructure. Such infrastructures depend on radio spectrum licenses, which have to be obtained by the maintaining parties. After obtaining such a license the maintaining parties sell air time. Therefore, customers are limited with the technology and available services as well as they have high cost, also for proximity calls.

However, wireless infrastructures which are license free are known in prior art. Such infrastructures are, for instance, Bluetooth, Wireless LAN (WLAN) or Worldwide Interoperability for Microwave Access (WiMAX).

In addition, it is also known in the art that network devices of almost every description can use the Universal Plug and Play (UPnP) standard for communication. The standard is developed to simplify the communication between devices within a network. Thereby the UPnP standard devices can use HTTP as a transfer protocol to be platform independent. Furthermore, Device Control Protocols (DCP) describe the used interfaces and services for communication which have to be provided by the different devices. A DCP is generally created in a markup language, like Extensible Markup Language (XML), to be readable for all devices which are capable of UPnP.

However, there is not known to use the UPnP standard for creating proximity phone calls. A DCP or a similar description for a mobile service is also not known.

### SUMMARY

These and other objects are solved by an apparatus comprising at least one interface for connecting to a wireless network. Further the apparatus comprises an advertising unit configured to advertise the presence of the apparatus within the wireless network. The apparatus includes also a presenting unit configured to present at least one mobile service described in a markup language and a transmission unit configured for accepting a request for a bidirectional communication via the wireless network from at least one second apparatus using the presented mobile service.

The apparatus may be arranged within a conventional mobile device or the like. The at least one interface of the apparatus may serve to connect the apparatus to a wireless network. The apparatus may comprise further interfaces which are suitable for different wireless networks. If suitable interfaces are already installed within the mobile device, these interfaces can be used for cost-efficient production.

Several protocols, like DHCP or Auto-IP, are known and can be used to configure the interfaces properly.

An advertising unit may be arranged to create and send advertising messages via the provided interface to indicate the presence of the apparatus within the network. These messages may be sent periodically as long as the activated apparatus resides within the network to advertise its presence to further devices. If sending the messages is stopped by the apparatus, the apparatus may not be located within the network by other devices. The advertising messages may comprise at least one unique identifier, like a universal unique identifier (UUID).

The apparatus may offer a mobile service to at least one second apparatus. For using a service offered by the apparatus, the second apparatus has to be able to take up the offered service. It has been found that the service, especially the mobile service, has to be presented in an easily readable form. It has further been found that using a markup language for describing the presented mobile service is particular suitable. A second apparatus can discover the presented mobile service in an easy way.

For example, the apparatus may present an URL for downloading a description of the offered services described in a markup language by the second apparatus. Moreover, the use of a markup language yields to that the description of the offered services can easily be read by multitude of devices. Further, the markup language can be read independently from the used infrastructure or platform.

In addition, the apparatus comprises a transmission unit to accept a request for a bidirectional communication via the wireless network from at least one second apparatus using the presented mobile service. The description of the mobile service may enable the second apparatus to establish a bidirectional communication with the apparatus by setting up the transmission unit of the apparatus according to the instructions defined in the description.

The application provides for bidirectional communication without basic cost using conventional mobile devices comprising an apparatus according to the application. What is more, the duration to service may be improved due to that the service is available immediately. The mobile device can be deployed straight out of the sales packages. There is no need to open or set up an account or purchase a SIM card.

According to a further embodiment, the apparatus comprises a discovering unit to locate at least one further apparatus. The apparatus itself may search for further devices having an apparatus. For example, the apparatus can listen to and be able to receive an advertising message sent by a further apparatus.

In addition, the discovering unit may be arranged for discovering the services presented by the further apparatus described in a markup language. The apparatus can discover the services of the further apparatus after locating the respective apparatus, for instance after receiving an advertising message. The apparatus may download the description of the service presented by the further apparatus in form of a URL. In particular, the discovering unit may determine whether the service presented by the further apparatus is the mobile service.

Furthermore, the discovering unit may be configured to send at least one discovering message and to interpret at least one respective response message sent by the further apparatus. The discovering unit may send actively discovery messages in order to locate further apparatuses which provide certain services, like the mobile service. Further the discovering unit is able to interpret the respective responses sent by a further apparatus to understand what services are available.

According to another embodiment, the arranged transmission unit may use the presented mobile service to set up a bidirectional communication with the further apparatus via the wireless network. The apparatus, especially the transmission unit, may use the instructions defined in the presented description to deploy units provided by the further apparatus to set up this communication. In particular, the bidirectional communication set up by the transmission unit may be a voice communication, like a phone call. The apparatus may be both a device and a control point.

According to a further embodiment, the apparatus may use the UPnP standard. This standard can be used by a wide range of devices. It is a universal standard independent from the used platform or network.

What is more, the mobile service can be presented in the form of a DCP. The DCP may be described in an XML format. In more detail the DCP according to this embodiment of the application may include services the apparatus will offer to further apparatuses, like the mobile service. Moreover, the actions which have to be performed for each service may be included within the DCP. The apparatus may invoke at least a second apparatus to use the offered services. Therefore, the DCP may comprise a list of available control instructions having corresponding parameters and arguments and state variables which modulate the status of the services during the running time. Furthermore, a unique identifier can be presented. This list can be passed to further interested apparatuses.

To manage a closed user group, a control unit can be arranged within the apparatus. For security reasons, it may be desirable that only a closed group of users is authorized to set up a bidirectional communication to each other. A closed user group may consist of office employees, community of gamers, a home community or the like. Therefore, according to a further embodiment of the application, an access unit may verify whether a user is an authorized member of such a closed group. Simple verification mechanism can be employed like using only a password as well as laborious mechanism having several encryption mechanisms depending on user specifications.

In a further embodiment, a closed user group may be formed by allocating certificates to desired users. A certificate may include a service provider who allocates the certificate, a signature of the service provider, validity and readings about the invited user, like user name, validity of the certificate and user signature. Further features are possible, like a public key, used encryption algorithm or the like. Every user having an apparatus according to the application may act as a service provider and each user can form a closed user group.

According to another embodiment of the application at least the closed user group can be displayed. The apparatus may comprise a display unit. The users of the closed group can be displayed through a list, like a buddy list or the like. Status variables of the users can also be shown. For example, it can be shown by icons, whether a user is available at the time.

The discovering unit may also comprise a determining unit to determine the provided channel capacity by the wireless network and to check whether the provided capacity is sufficient to set up a bidirectional communication, especially a voice communication. Insufficient capacity may be displayed. The discovering unit may check several wireless networks in case the networks are provided. The user may select another infrastructure or try it again later.

According to a further embodiment, the wireless networks to which the apparatus are connected may be license free networks. For example, the Industrial, Scientific and Medical band (ISM-band), between 2,402 GHz and 2,480 GHz can be used license free over the world. Bluetooth, WLAN and/or WiMAX work within a license free band. Thereby, Bluetooth offers advantages by short ranges of voice communications. Instead of this, WiMAX is particular suitable for long distances. The determining unit may be configured to choose the most appropriate network.

A further aspect of the application is an apparatus comprising at least one interface for connecting to a wireless network. The apparatus includes a discovering unit configured to locate at least a further apparatus within the wireless network and configured to discover at least one mobile service presented by the further apparatus described in a markup language. Additionally the apparatus comprises a transmission unit configured to use the presented mobile service to set up a bidirectional communication with the further apparatus via the wireless network.

Another aspect of the application is a system, comprising at least one first mobile device comprising an apparatus having at least one interface for connecting to a wireless network. The apparatus comprises an advertising unit configured to advertise the presence of the apparatus within the wireless network. The apparatus includes also a presenting unit configured to present at least one mobile service described in a markup language and a transmission unit configured for accepting a request for a bidirectional communication via the wireless network from at least one second apparatus using the presented mobile service. The system further comprises at least one second mobile device comprising an apparatus, wherein the apparatus comprises at least one interface for connecting to a wireless network and a discovering unit configured to locate at least a further apparatus within the wireless network as well as configured to discover at least one mobile service presented by the further apparatus described in a markup language. The apparatus also includes a transmission unit configured to use the presented mobile service to set up a bidirectional communication with the further apparatus via the wireless network.

For example, two mobile devices may be connected directly to each other, for instance via Bluetooth. Depending on the power of the used Bluetooth and other parameters, like the configuration of the antenna, a range of more than 100 m can easily be achieved. Bluetooth is especially suitable for phone calls of long periods.

According to another embodiment of the application the system may comprise further connecting devices like router, bridge, hub, switch or the like.

For instance, two users can set up a voice communication between the respective mobile devices using WLAN. Such a system may include other and further connecting devices, like WLAN routers. In particular a wide range can be reached using WiMAX instead of WLAN. In general, ranges up to 10 km and more can easily be achieved. Therefore, an unlimited range can theoretically be reached with suitable technology.

A further aspect of the application is an apparatus, comprising means for connecting the apparatus to a wireless network and means for advertising the apparatus within the wireless network. Furthermore, the apparatus includes means for presenting at least one mobile service described in a markup language and means for accepting a request for a bidirectional communication via the wireless network from at least one second apparatus using the presented mobile service are arranged within the apparatus.

Another aspect of the application is a method, comprising connecting at least one apparatus to a wireless network and advertising the presence of the apparatus within the wireless network. The method includes further presenting at least one mobile service described in a markup language and accepting a request for a bidirectional communication via the wireless network from at least one second apparatus using the presented mobile service.

A further aspect is a computer readable medium having a computer program stored thereon, the computer program comprises instructions operable to cause a processor to perform at least the above mentioned method.

The present application can be deployed for home calls, office calls, small community's calls, coach to trainee calls, gamers and the like. What is more the present application can also be used for data transmission, like file/content sharing or gaming.

These and other aspects of the application will be apparent from and elucidated with reference to the detailed description presented hereinafter. The features of the present application and of its exemplary embodiments as presented above are understood to be disclosed also in all possible combinations with each other.

### BRIEF DESCRIPTION OF THE FIGURES

In the figures show:

FIG. 1: An exemplary illustration of an apparatus according to the application;

FIG. 2: a first exemplary system according to the application;

FIG. 3: a second exemplary system according to the application;

FIG. 4: an exemplary flow chart of a method according to the application;

FIG. 5: an exemplary embodiment of a certificate given to a user;

FIG. 6: an exemplary screenshot of a displayed closed user group.

### DETAILED DESCRIPTION OF THE APPLICATION

In the following detailed description of the present application, exemplary embodiments of the present application will be described.

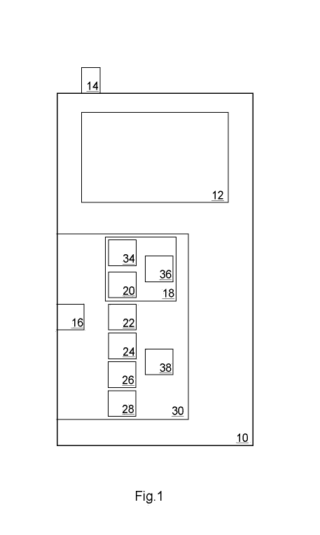

FIG. 1 illustrates an exemplary embodiment of a mobile device 10 comprising an apparatus 30 according to embodiments. The depicted mobile device 10 comprises in general a display unit 12 and an interface 14 formed as an antenna.

The apparatus 30 may include a further interface 16. This interface 16 may be a Bluetooth interface or another suitable interface for connecting the apparatus to a wireless network, like WLAN or WiMAX. An interface 16, for example a Bluetooth interface, may already installed within the mobile device 10. Hence, it is possible to use this interface 16 to decrease costs.

Furthermore, an advertising unit 22, a presenting unit 24, a transmission unit 26, a discovering unit 28, a control unit 18 and a computer product 38 are arranged within the apparatus 30.

The advertising unit 22 serves for advertising the presence of the apparatus 30 or mobile device 10 within the wireless network. Therefore, advertising messages can be generated by the advertising unit 22 comprising at least a unique identifier.

Information about the apparatus 30 and/or the mobile device 10, like manufacturer or serial number, may be presented by the presenting unit 24 as well as the offered services by the apparatus 30, respectively mobile device 10. The UPnP standard can be used for presenting. According to UPnP standard, the services and information can be defined by a DCP. A DCP may include the description of the offered services described in an XML format. It may be possible that an URL is presented by the presenting unit 24 for downloading the description by an interested second device for an easy processing.

In more detail the DCP according to the application includes the services the mobile device 10 will offer to other devices, like the mobile service for at least a proximity call or the presence service. Moreover, the actions which have to be performed for each service are included within the DCP according to the application. The apparatus 30 may invoke at least a second apparatus 30 to use the offered services. Therefore, the DCP may comprise a list of available actions having corresponding parameters and arguments and state variables, which modulate the status of the services during the running time. The list can be passed to at least a second apparatus 30. All UPnP capable devices are able to read this description due to its chosen language, independently from the used infrastructure or platform. Therefore, the mobile device 10 can be used independently of certain interfaces or infrastructures.

What is more, the transmission unit 26 is arranged at least to set up a bidirectional communication, in particular a voice communication, via the wireless network. This communication may be a direct peer to peer connection between two mobile devices 10 or a peer to peer connection using further connecting devices. The transmission unit 26 is configured to put the offered mobile service presented by the presenting unit 24 into action.

The discovering unit 28 is arranged to locate further devices within the wireless network. In addition the discovering unit 28 may discover at least the mobile service offered by a further apparatus 30. For instance, the discovering unit 28 may download the description in case the further apparatus 30 presents an URL. Then, the discovering unit 28 may determine whether the downloaded service is a mobile service.

In other words, the apparatus 30 may be not only a device but also a control point in the context of UPnP standard. Each user may act as a service provider. The diversity of services increases.

The control unit 18 is arranged to serve several tasks and therefore may comprise further units 20, 34, 36. The control unit 18 may be configured to manage a closed user group and to check the available channel capacity. Thus an access unit 20, a verification unit 34 and a determining unit 36 may be arranged within the control unit 18.

Thereby, the access unit 20 serves to form a closed user group. The access unit 20 may generate certificates according to a predetermined parameter set by the user who acts as the service provider. Other possibilities in forming a closed user group are also conceivable. Further, the apparatus 30 may be designed such that every apparatus 30 may act as a service provider. The configuration can be adjusted according to user specification.

The verification unit 34 may verify whether a user is an authorized member of a closed user group. For instance, the allocated certificate can be checked by the verification unit 34. However, other security systems can be implemented.

The determining unit 36 is provided to determine whether a channel capacity is sufficient to set up a bidirectional communication, especially a voice communication.

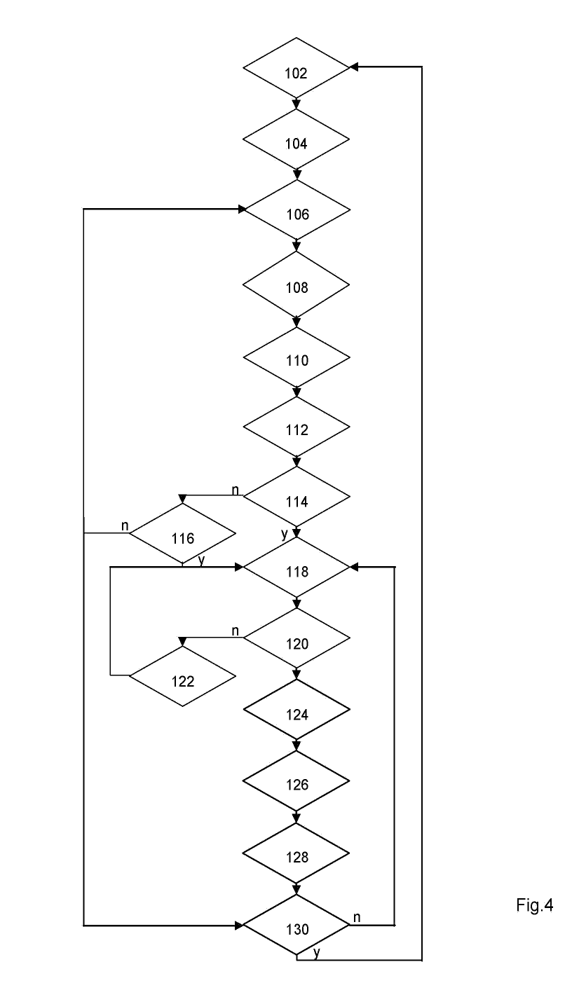

Finally the apparatus comprises a computer program product 38. The computer program product 38 may comprise a computer program for implementing a method as illustrated in FIG. 4 on a device 10.

Not shown in FIG. 1 is a controller which manages the mentioned units to work properly.

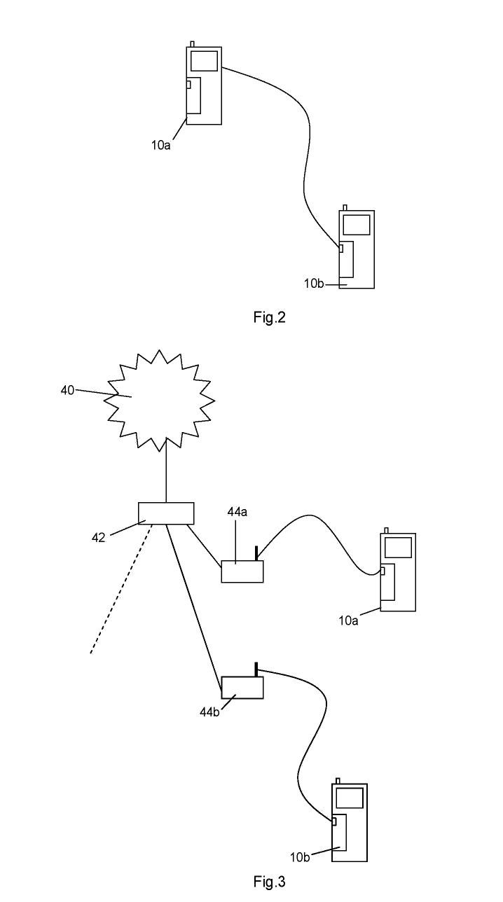

FIG. 2 shows a first exemplary system according to the application. Two mobile devices 10a, 10b according to the application are illustrated. It is apparent that the mobile devices 10a, 10b both are connected directly to each other, for instance via Bluetooth. Depending on the power of the used Bluetooth and other parameters, like the configuration of the antenna of the mobile devices 10a, 10b or the environment, a range of more than 100 m for a phone call can easily be achieved.

In FIG. 3 a second exemplary system according to the application is illustrated. This system comprises also at least two mobile devices 10a, 10b. In addition, connecting devices 44a, 44b and 42 are shown. The connecting devices 44a, 44b may be for example WLAN-routers and each of them may be connected to the connecting device 42, which may be a bridge, hub or a switch. In turn, the connecting device 42 comprises a connection to a further network 40, like the internet.

For instance, two users can set up a voice communication between the respective mobile devices 10a, 10b using WLAN. The signal path according to the depicted exemplary system runs from a first mobile device 10a to a second mobile device 10b via WLAN routers 44a, 44b and a switch 42. Such a system may include other and further connecting devices.

Using WiMAX instead of WLAN due to its greater range, big distances may be achieved. In general, ranges up to 10 km and more can easily be achieved. Therefore, an unlimited range can theoretical be reached with suitable technology.

The operating mode of the above described apparatus 30 and systems will be explained in FIG. 4.

In FIG. 4 is shown a flow chart of a method according to embodiments. In the first step 102 a mobile device 10 comprising the apparatus 30 is connected to a wireless network via a suitable interface 14, 16. For example, a user can select a license free infrastructure, like Bluetooth, WLAN or WiMAX. Further infrastructures are also possible. For instance, a user having an apparatus, respectively mobile device 10 may enter into such a wireless network or the user may activate the mobile device 10, in particular the apparatus 30 within the wireless network.

The configuration of the interface 14, 16 may occur subsequently. The UPnP standard allows using different protocols for configuration. For the case a DHCP server is included within the network this server can be used to distribute, for example, IP-addresses. Other protocols, as for example Auto-IP or similar protocols, may be used for automatic configuration in the case that a server is not provided.

In the following step 104, the connected mobile device 10 may advertise its presence within the network and in step 106 it may locate for other devices within the network. The steps 104, 106 can be performed at the same time. These functions can be performed with a so called Simple Service Discovery Protocol (SSDP). Messages may be sent periodically while the mobile device 10 is connected to the wireless network. Other devices within the network may be located by the mobile device 10 or they may respond to the sent advertising messages. The messages may comprise at least one unique identifier of the sending mobile device 10.

It may be also possible that the apparatus 30 sends discovery messages in order to locate apparatuses 30 which offer certain services, like the mobile service. Respective response messages may be analyzed by the apparatus 30.

In the next step 108, the apparatus 30 may present the offered mobile service via the presenting unit 24. The services are described in a markup language, like XML. The description is normally presented by a Device Control Protocol (DCP). It is possible that the presenting unit 24 presents an URL to which a second mobile device 10b may access.

In the case at least one further device 10b is located by the mobile device 10 the mobile device 10 is able to discover the services presented by the further device due to the use of UPnP standard. This is performed in step 110. For instance, the description of the service can be downloaded by the mobile device 10. The other device may also discover the services presented by the mobile device 10 in an XML format.

In the following step 112 the mobile device 10 may determine whether the presented services by the other device comprises the mobile service. If so the address of the second device, for instance a second mobile device 10b, can be determined by the first mobile device 10a using for example the Reverse Address Resolution Protocol (RARP). RARP is configured to get unknown IP-addresses of certain devices.

In the subsequent step 114 it may be verified whether the other user is an authorized user of an already existing closed user group. Several security methods are conceivable and known in the art. For example, a user may authenticate himself to another user by using a password, a certificate or a similar method.

In case the users of the first and second mobile device 10a, 10b are not authorized members of the same closed user group each of the users may send a request to become an authorized member of the closed user group provided by the other user (step 116). The other user, who acts in this case as the service provider, may response to the request by allocating a certificate or he may deny an access to the closed user group.

If the service provider allocates a denial, the requesting user may start again at any foregoing step, preferred at step 106 to locate other devices. Another possibility is to reach the last step 130. In the last step 130 the user may deactivate at least the apparatus 30 or leave the range of the wireless infrastructure.

However, if the service provider sends a certificate as a response, the response includes at least the certificate and a description of the allowed service. The message may comprise further the host, validity, a public key and/or signature of the service provider. The certificate may comprise the name of the user given the certificate, a serial number, the used encryption algorithm, a signature and the like.

Every user may thereby act as a service provider and therefore may form and manage a closed user group. A user can also invite another user to become an authorized member of the closed user group.

After the above elucidated steps 114 or 116 at least the closed user group is displayed on the display 12 of the mobile device 10 in step 118. For instance, the user names of the closed group may be listed. It is conceivable that further devices or other users may be displayed. Moreover, state variables of the users or the respective apparatuses 30 may also be shown. For instance, after each user name a subsequent icon may point out whether a user is available or not. Then, the user of the first apparatus can choose a second user listed on the display 12 for calling.

Before the communication, especially a voice communication, is set up, the control unit 18 determines in step 120 whether the channel capacity provided by the infrastructure is sufficient for the voice communication. If the capacity is insufficient it is displayed in step 122. The user may try to call once again in step 120 or may select another infrastructure if available.

If the capacity is sufficient, the communication is set up in step 124 by the transmission units 26 of the respective apparatuses 30. Thereby, the transmission unit 26 sends a request to use the instructions and parameter described in an XML format to set up the mobile service provided by the second mobile device 10b. In the following step 126 the transmission unit 26 of the second mobile device 10b accepts the request from the apparatus 30. UPnP provides thereby to use HTTP or streaming protocols as transfer protocol. Since every connected mobile device 10 comprises at least a unique MAC-address, setting up a bidirectional communication can be done in a simple manner. If Bluetooth is deployed as the bearer, the use of a MAC-address is sufficient. In the case WiMAX or WLAN is used as the bearer, an IP-address may additionally be used. However, the IP-addresses can be achieved easily by using, for example, the RARP protocol.

In step 128 the bidirectional communication can be terminated.

As already mentioned above, in the following step 130 the user may deactivate at least the apparatus 30 or leave the range of the wireless infrastructure. When a user leaves the infrastructure or deactivates his apparatus 30 the further users may be informed by a changed icon on their display which represented the status of the user who left.

However, the method can be terminated at any step of the method which is not shown in the flow chart of FIG. 4. What is more, steps may also be omitted. For example, step 114 can be omitted, if a security system is not implemented. Also determining the channel capacity in step 120 may be optional.

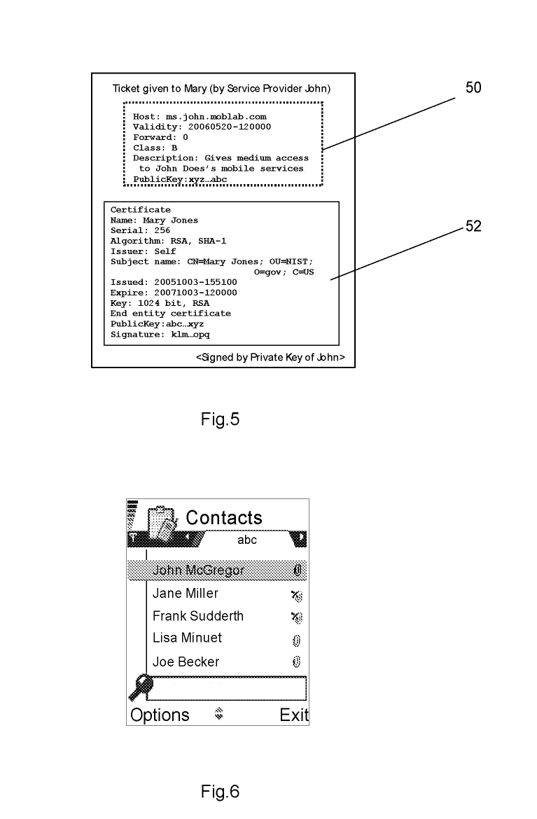

In addition, FIG. 5 illustrates an exemplary embodiment of a certificate given to a user. The certificate serves for authentication of a user being an authorized member of a closed user group. A service provider may form such a closed user group by allocating certificates to desired users. Every user of the closed group may act as the service provider. It is also possible that only one certain user or a few users may act as the service provider.

In this exemplary embodiment a certificate is given by the service provider John to the user Mary. Within a dashed rectangle 50 the host and validity is denoted. Moreover a description is denoted that the user Mary gets medium access to John Doe's mobile services. Additionally a public key, a forward parameter and a class parameter is depicted.

In the second rectangle 52 the full name of the user, in this example Mary Jones, is also denoted as a serial number. Furthermore, the used encryption algorithm is shown. In this example the so called RSA algorithm and the Secure Hash Algorithm (SHA) SHA-1 are used. Normally, the RSA algorithm is used for public key encryption and general encryption. Moreover the SHA-1 algorithm developed by the National Institute of Standards and Technology (NIST) of the USA is used for signature with the aid of a hash function. Similar algorithms are also conceivable. What is more, the issued date and expired data are denoted as well as an allocated signature. The shown certificate comprises a validity of approximately two years. After this period the certificate has to be renewed.

Finally the certificate is signed by the private key of the service provider John. Other embodiments of a certificate, especially further or omitted readings are also possible.

FIG. 6 shows an exemplary screenshot of a displayed closed user group. This group is listed under the category contacts. Five user names are listed whereby the first name is chosen for a call pointed out by highlighting grey. Further depicted are icons after the user names representing the status of the respective users. In the case the user is currently not available within the network a slashed icon is depicted, as for example shown in line 2 or 3.

The application has been described above by means of exemplary embodiments. It should be noted that there are alternative ways and variations which, in light of the teachings hereof, will be evident to a any person of skill in the art and can be implemented without deviating from the scope and spirit of the appended claims.

Furthermore, it is readily clear for any skilled person that the logical blocks in the schematic block diagrams as well as the flowchart and algorithm steps presented in the above description may at least partially be implemented in electronic hardware and/or computer software, wherein it depends on the functionality of the logical block, flowchart step and algorithm step and on design constraints imposed on the respective devices to which degree a logical block, a flowchart step or algorithm step is implemented in hardware or software. The presented logical blocks, flowchart steps and algorithm steps may for instance be implemented in one or more digital signal processors, application specific integrated circuits, field programmable gate arrays or other programmable devices. The computer software may be stored in a variety of storage media of electric, magnetic, electro-magnetic or optic type and may be read and executed by a processor, such as for instance a microprocessor. To this end, the processor and the storage medium may be coupled to interchange information, or the storage medium may be included in the processor.

What is claimed is:

1. An apparatus, comprising:
at least one interface for connecting to a wireless network;
an advertising unit configured to advertise presence of the apparatus within the wireless network;
a presenting unit configured to present at least one mobile service described in a markup language;
a transmission unit configured for accepting a request for a bidirectional communication via the wireless network from at least one second apparatus using the presented mobile service.

2. Apparatus according to claim 1, further comprising a discovering unit configured to locate a further apparatus within the wireless network.

3. Apparatus according to claim 2, wherein the discovering unit is configured to discover at least the mobile service presented by the further apparatus described in a markup language.

4. Apparatus according to claim 2, wherein the discovering unit is configured to send at least one discovering message to the further apparatus and to interpret at least one respective response message sent from the further apparatus.

5. Apparatus according to claim 1, wherein the transmission unit is configured to use the presented mobile service to set up a bidirectional communication with the further apparatus via the wireless network.

6. Apparatus according to claim 1, wherein the bidirectional communication set up by the transmission unit is a voice communication.

7. Apparatus according to claim 1, wherein the apparatus is configured to use Universal Plug and Play standard.

8. Apparatus according to claim 1, wherein the presenting unit is configured to present the mobile service in the form of a Device Control Protocol in an Extensible Markup Language.

9. Apparatus according to claim 1, wherein the presenting unit is configured to present at least one of:
A) control instructions,
B) unique identifier.

10. Apparatus according to claim 1, further comprising a control unit configured to manage at least one closed user group.

11. Apparatus according to claim 10, wherein the control unit comprises an access unit configured to allocate certificates to desired users for forming a closed user group.

12. Apparatus according to claim 10, wherein the control unit comprises a verification unit configured to verify whether a user is an authorized member of the closed user group.

13. Apparatus according to claim 1, further comprising a display unit configured to display at least the authorized members of the closed user group.

14. Apparatus according to claim 13, wherein the display unit is configured to display state variables of at least the authorized members of the closed user group.

15. Apparatus according to claim 1, wherein the at least one interface is configured to connect the apparatus to at least one of:
A) Bluetooth,
B) tireless LAN,
C) WiMAX,
service.

16. Apparatus according to claim 10, wherein the control unit comprises a determining unit configured to determine channel capacity provided by the wireless network.

17. An apparatus, comprising:
at least one interface for connecting to a wireless network;
a discovering unit configured to locate at least a further apparatus within the wireless network;
the discovering unit configured to discover at least one mobile service presented by the further apparatus described in a markup language;
a transmission unit configured to use the presented mobile service to set up a bidirectional communication with the further apparatus via the wireless network.

18. A system, comprising:
at least one first mobile device comprising an apparatus; and
at least one second mobile device comprising an apparatus, the apparatus, wherein the apparatus comprises
at least one interface for connecting to a wireless network;
a discovering unit configured to locate at least a further apparatus within the wireless network;
the discovering unit configured to discover at least one mobile service presented by the further apparatus described in a markup language;
a transmission unit configured to use the presented mobile service to set up a bidirectional communication with the further apparatus via the wireless network.

19. System according to claim 18, further comprising at least one connecting device wherein the connecting device is at least one of:
A) router,
B) bridge,
C) hub,
D) switch.

20. An apparatus, comprising:
means for connecting the apparatus to a wireless network;
means for advertising the apparatus within the wireless network;
means for presenting at least one mobile service described in a markup language;
means for accepting a request for a bidirectional communication via the wireless network from at least one second apparatus using the presented mobile service.

21. A method, comprising:
connecting at least one apparatus to a wireless network;
advertising the presence of the apparatus within the wireless network;
presenting at least one mobile service described in a markup language;
accepting a request for a bidirectional communication via the wireless network from at least one second apparatus using the presented mobile service.

22. Method according to claim 21, further comprising locating at least a further apparatus within the wireless network.

23. Method according to claim 21, further comprising discovering at least the mobile service presented by the further apparatus described in a markup language.

24. Method according to claim 21, further comprising sending at least one discovery message and interpreting at lest one respective response message.

25. Method according to claim 21, using the presented mobile service to set up a bidirectional communication with the second apparatus via the wireless network.

26. Method according to claim 21, further comprising use Universal Plug and Play standard.

27. Method according to claim 21, further comprising defining at least the presented mobile service in form of a Device Control Protocol in an Extensible Markup Language.

28. Method according to claim 21, further comprising managing at least one closed user group.

29. Method according to claim 28, wherein managing at least one closed user group comprises forming the closed user group by allocating certificates to desired users.

30. Method according to claim 28, wherein managing the at least one closed user group comprises verifying whether a user is an authorized member of the closed user group.

31. Method according to claim 21, further comprising displaying at least the authorized members of the closed user group.

32. Method according to claim 31, wherein displaying at least the authorized members comprises displaying state variables of at least the authorized members of the closed user group.

33. Method according to claim 21, further comprising determining the channel capacity provided by the wireless network.

34. A computer readable medium having a computer program stored thereon, the computer program comprising:
instructions operable to cause a processor to perform a method according to claim 21.
